(19) United States
(12) Patent Application Publication
(10) Pub. No.: US 2005/0203826 A1
(43) Pub. Date: Sep. 15, 2005

(54) Implied spread trading system

(75) Inventors: James W. Farrell, Carol Stream, IL (US); James R. Krause, Palatine, IL (US)

Correspondence Address: BANNER & WITCOFF, LTD., TEN SOUTH WACKER DRIVE, SUITE 3000, CHICAGO, IL, 60606, US

(73) Assignee: Chicago Mercantile Exchange, Inc., Chicago, IL (US)

(21) Appl. No.: 10/986,967

(22) Filed: Nov. 12, 2004

Related U.S. Application Data
(60) Provisional application No. 60/552,478, filed on Mar. 12, 2004.
(60) Provisional application No. 60/553,519, filed on Mar. 16, 2004.

(51) Int. Cl. G06F 17/60

(52) U.S. Cl. 705/37

(57) ABSTRACT

Systems and methods are provided for creating and processing implied spread products that include one or more legs having nonstandard tick levels. One or more multiple financial instrument legs consist of underlying financial instruments that have standard tick levels and result in the leg(s) having a nonstandard tick level. The use of underlying financial instruments that have standard tick levels facilitates the linking of spread product markets to markets for the underlying financial instruments.

The present application claims the benefit U.S. Provisional Application No. 60/552,478, filed Mar. 12, 2004 and U.S. Provisional Application No. 60/553,519, filed Mar. 16, 2004. The entire disclosures of both priority applications are hereby incorporated by reference.

### FIELD OF THE INVENTION

The present invention relates to the trading of financial instruments and, in particular, to methods and systems that utilize implied spread products that include one or more legs having a nonstandard tick value.

### DESCRIPTION OF THE RELATED ART

Spread products, such as butterfly spreads, are used by traders to hedge against risks. A typical spread product includes multiple legs, each of which may include one or more underlying financial instruments. A butterfly spread product, for example, may include three legs. The first leg may consist of buying a first contract. The second leg may consist of selling two of a second contract. And, the third leg may consist of buying a third contract. The price of a butterfly spread product may be calculated as:
Butterfly=Leg1−2×Leg2+Leg3 (equation 1)
where Leg1 equals the price of the first contract, Leg2 equals the price of the second contract and Leg3 equals the price of the third contract.

Prior art trading systems and methods have limited the ability to trade spread products. A spread product may include one or more legs that have prices at nonstandard tick levels. For example, if a butterfly spread product is quoted in 0.5 tick levels, leg2 may consist of two contracts each having a 0.25 tick level. Since a tick level of 0.25 is not a standard tick level, prior art systems and methods have been unable to match orders for the spread product with individual orders for the underlying financial instruments. Among other disadvantages, the failure to link markets for spread products with orders for underlying contracts limits market liquidity and market depth.

Therefore, there is a need in the art for systems and methods that link markets for spread products to markets for underlying financial instruments.

### SUMMARY OF THE INVENTION

Aspects of the present invention overcome problems and limitations of the prior art by providing trading methods and systems that utilize a combinations of financial instruments having prices at different tick levels to result in a price for a multiple financial instrument leg of a spread product that has a nonstandard tick level. The ability to use multiple financial instruments at different tick levels allows for the creation of implied spread products and the linking of spread product markets to markets for the underlying financial instruments.

In certain embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention;

FIG. 2 illustrates a process for creating an implied spread product, in accordance with an embodiment of the invention;

FIG. 3 illustrates an implied spread product, in accordance with an embodiment of the invention;

FIG. 4 illustrates an implied spread product being traded among a plurality of traders in accordance with an embodiment of the invention; and

FIG. 5 illustrates a method of creating and processing an implied spread product, in accordance with an embodiment of the invention.

### DETAILED DESCRIPTION OF THE INVENTION

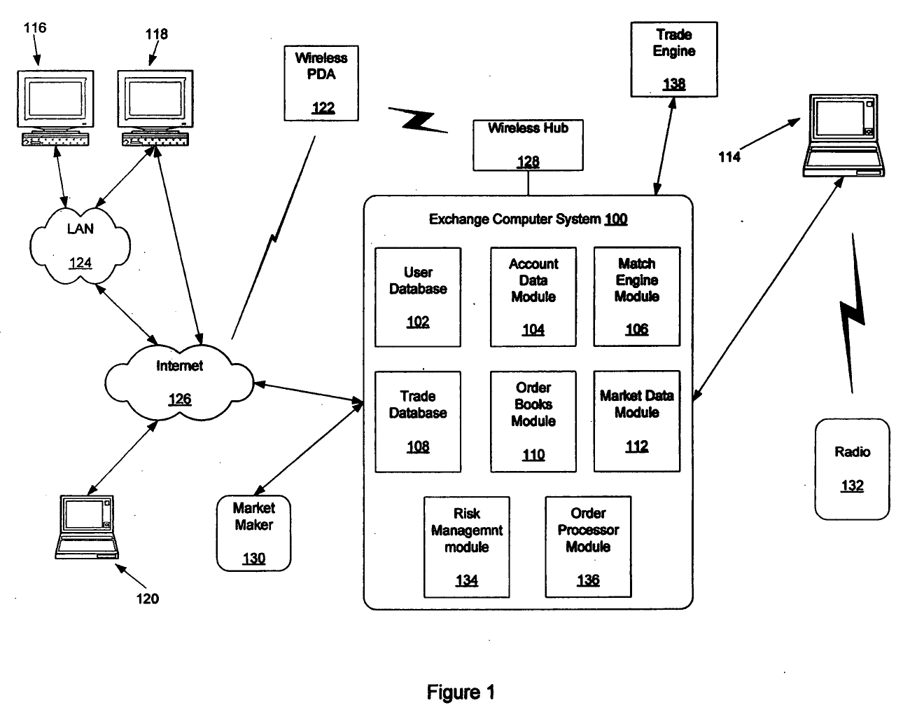

Aspects of the present invention are preferably implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords potentially with other information to identify users uniquely or collectively. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose variable defined derivative product and aggregate order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems. Coupling can be direct as described or any other method described herein.

The operations of computer devices and systems shown in FIG. 1 may be controlled by computer-executable instructions stored on a computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

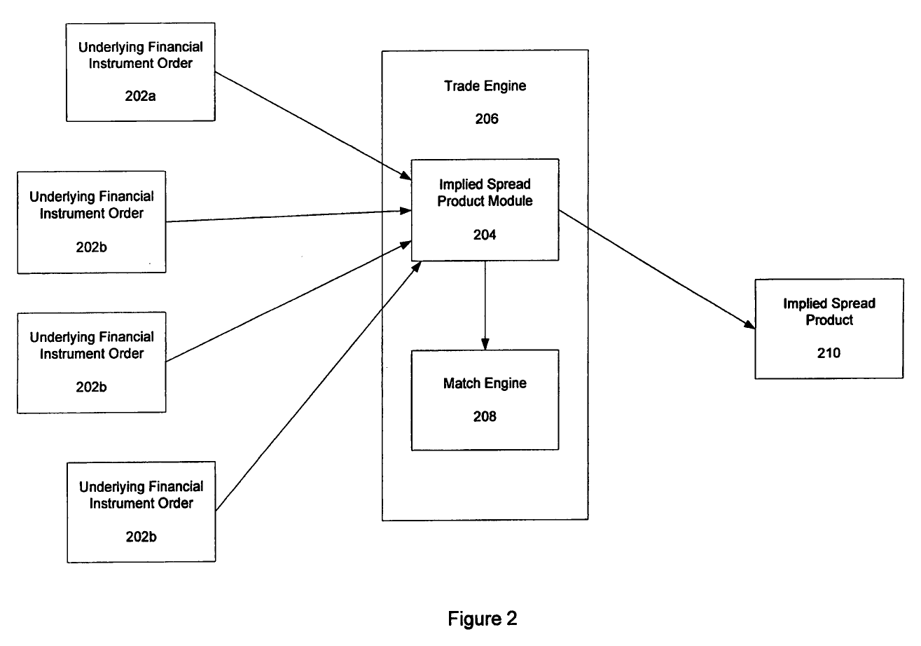

FIG. 2 illustrates a process for creating an implied spread product, in accordance with an embodiment of the invention. As used herein an implied order is an order created from individual outright orders that are available in the market place. A group of underlying financial instruments 202a-202d are received at an implied spread product module 204 of a trade engine 206. Implied spread product module 204 may be configured to create an implied spread product 210 from a plurality of underlying contracts 202a-202d. As will be described in detail below, the implied spread product includes underlying financial instruments priced at standard tick levels. Trade engine 206 may also include a match engine module 208 that matches an order for a spread product with orders for the underlying financial instruments. In some embodiments of the invention, the functions of implied spread product module 204 and match engine module 208 may be performed by one or more of the elements within exchange computer system 100 (shown in FIG. 1).

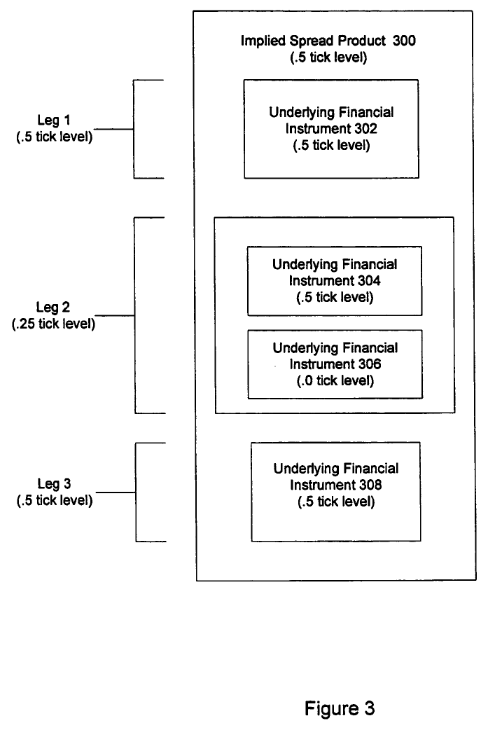

FIG. 3 illustrates an implied spread product 300, in accordance with an embodiment of the invention. In the example shown, implied spread product 300 has a price that is at a standard tick level of 0.5. As used herein, a standard tick level is a price level that financial instruments are bought and sold at an exchange. Implied spread product 300 represents an implied butterfly spread product that includes a leg 1 at a 0.5 tick level and consisting of an underlying financial instrument 302 at a 0.5 tick level. A leg 2 is at a 0.25 tick level, which is a nonstandard tick level, and includes underlying instrument 304 and underlying instrument 306. A leg 3 is at a 0.5 tick level and includes underlying instrument 308. In one embodiment of the invention, underlying financial instruments are Eurodollar contracts. One leg of a butterfly spread product may comprise a calendar spread product. A butterfly spread product may also include two calendar spread products.

The presence of a nonstandard tick level in leg 2 has prevented prior trading systems from linking spread product markets with markets for underlying financial instruments. This is because underlying financial instruments cannot be traded at the nonstandard tick levels. Implied spread product 300 solves this problem by including a combination of underlying financial instruments that make up a multiple financial instrument leg so that the resulting price level is at a standard tick level. Underlying contract 304 has a standard tick level of 0.5 and underlying contract 306 has a standard tick level of 0.0. The resulting tick level is determined by averaging the prices of the multiple financial instrument leg. In the example shown, the 0.5 and 0.0 tick levels result in a combined 0.25 tick level for the combined two financial instruments.

One skilled in the art will appreciate that aspects of the invention are not limited to producing a nonstandard tick level from the combination of two financial instruments. In other embodiments, 3, 4 or more financial instruments may be combined with different tick levels to result in a combination of financial instruments having a nonstandard tick level. For example, a leg of an implied spread product may consist of three underlying financial instruments having tick levels of 0.75, 0.0 and 0.25 which would result in a leg having an overall tick level of 0.3333. The quantities of underlying financial instruments and ratios of tick levels may be selected to obtain a desired tick level, with the limitation that all underlying financial instruments must have standard tick levels.

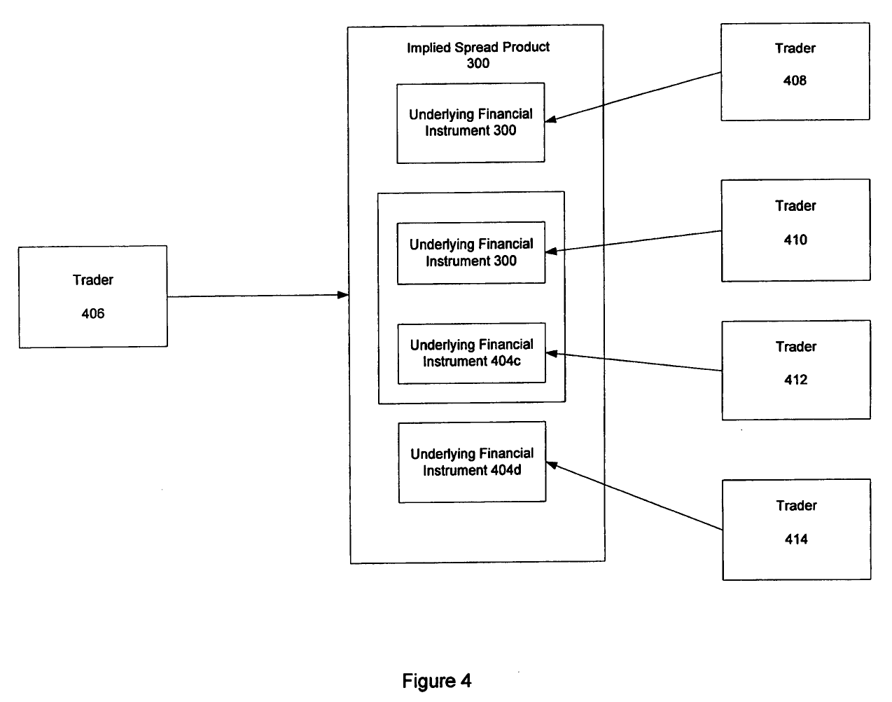

FIG. 4 illustrates an implied spread product 402 being traded among a plurality of traders in accordance with an embodiment of the invention. Implied spread product 402 consists of underlying financial instruments 404a-404d. Each one of the financial instruments is at a standard ticket level, even though the combination of underlying financial instrument 404b and 404c may result in a leg having a nonstandard tick level. The existence of underlying financial instruments at standard tick levels facilitates the linking of a spread product and underlying financial instrument markets. In the example shown, trader 406 may buy our sell a spread contract represented by implied spread contract 402 and traders 408, 410, 412 and 414 may buy or sell the underlying financial instruments.

In one embodiment of the invention, an exchange may require a single trader to buy or sell all of the financial instrument that make up a multiple financial instrument leg of an implied spread contract. In the example shown in FIG. 4, a single trader would be required to buy or sell both financial instruments 404b and 404c.

When an underlying financial product is purchased or sold for a price that is better than the price included in the implied spread product, the trader buying or selling the spread product may get a better fill than expected. For example, if a trader purchased implied spread product 300 and both underlying contracts 304 and 306 were available at the same price at a 0.0 tick level, the trader would get a better fill than expected.

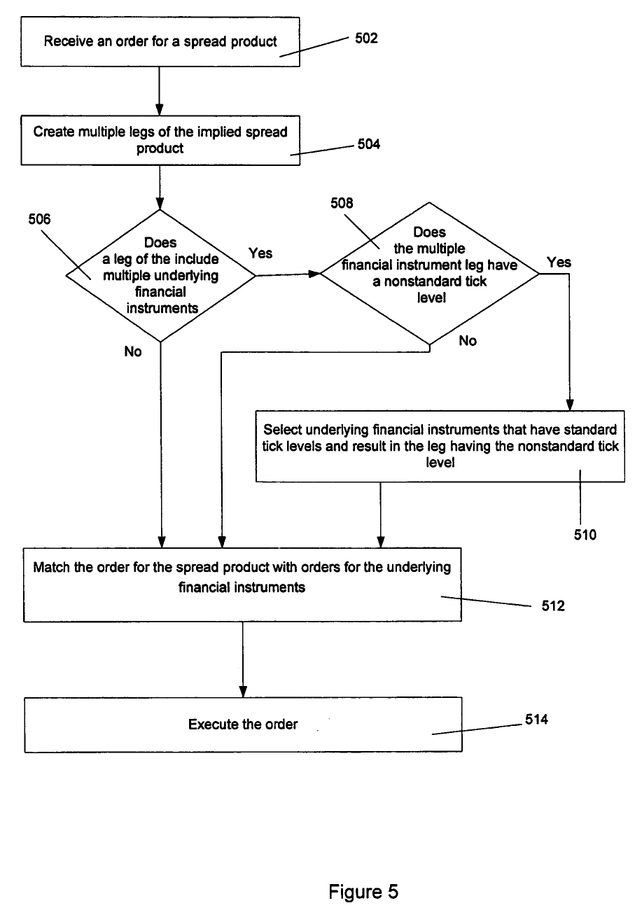

FIG. 5 illustrates a method of creating and processing an implied spread product, in accordance with an embodiment of the invention. First, in step 502 an exchange or other trading entity receives an order for a spread product. Next, multiple legs of the implied spread product are created in step 504. It is then determined whether a leg includes multiple underlying financial instruments in step 506. When a leg does include multiple financial instruments, it is next determined whether the multiple financial instrument leg has a nonstandard tick level in step 508. When the multiple financial instrument leg has a nonstandard tick level, in step 510, underlying financial instruments are selected that have standard tick levels and result in the leg having the nonstandard tick level. In one implied butterfly spread embodiment, an underlying financial instrument having a tick level above the nonstandard tick level and an underlying financial instrument having a tick level below the nonstandard tick level are selected.

In step 512, the order for the spread product is matched with one or more orders for the underlying financial instruments. Finally, the orders are executed in step 514.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention. For example, aspects of the invention may be used with any number of combinations of spread strategies that when examined on a link-by-link basis are comprised of the same underlying financial instruments.

1. A computer implemented method of processing an order for a multiple leg spread product based on underlying financial instruments, the method comprising:
(a) receiving an order for the spread product;
(b) creating a multiple underlying financial instrument leg of an implied spread product having a nonstandard tick level with multiple underlying financial instruments having standard tick levels and when combined result in the nonstandard tick level; and
(c) matching the order for the spread product with orders for the underlying financial instruments.

2. The computer-implemented method of claim 1, wherein the spread product comprises a butterfly spread product and the multiple underlying financial instrument leg comprises a first underlying financial instrument having a price at a standard tick level below the nonstandard tick level and a second underlying financial instrument having a price at a standard tick level above the nonstandard ticket level.

3. The computer implemented method 1, wherein the spread product comprises a pack spread.

4. The computer implemented method 1, wherein the spread product comprises a butterfly spread.

5. The computer-implemented method of claim 4, wherein the legs of the butterfly spread product comprises Eurodollar contracts

6. The computer implemented method of claim 4, wherein one leg of the butterfly spread product comprises a calendar spread product.

7. The computer implemented method of claim 4, wherein the butterfly spread product comprises two calendar spread products.

8. A computer-implemented method of creating a leg of a multiple leg spread product that has a nonstandard tick level, the method comprising:
combining multiple underlying financial instruments having standard tick levels and that when combined result in a leg having a nonstandard tick level.

9. The computer-implemented method of claim 8, wherein the spread product comprises a butterfly spread product and the multiple underlying financial instruments comprise a first financial instrument having a price at a standard tick level below the nonstandard tick level and a second financial instrument having a price at a standard tick level above the nonstandard ticket level.

10. The computer-implemented method of claim 9, wherein the legs of the butterfly spread product comprises Eurodollar contracts

11. The computer implemented method of claim 9, wherein one leg of the butterfly spread product comprises a calendar spread product.

12. The computer implemented method of claim 9, wherein the butterfly spread product comprises two calendar spread products.

13. The computer-implemented method of claim 8, wherein the spread product comprises a pack spread.

14. A computer-implemented method of linking a market for a spread product that comprises multiple legs of underlying financial instruments with a market for the underlying financial instruments, the method comprising:
creating a multiple financial instrument leg having a nonstandard tick level with multiple financial instruments having prices that have standard tick levels and when combined result in the nonstandard tick level.

15. The computer-implemented method of claim 14, wherein the spread product comprises a butterfly spread product and the multiple financial instrument leg comprises a first financial instrument having a price at a standard tick level below the nonstandard tick level and a second financial instrument having a price at a standard tick level above the nonstandard ticket level.

16. The computer-implemented method of claim 14, wherein the spread product comprises a pack spread.

17. A trading system comprising:
an implied spread product module that receives an order for a spread product and creates an implied spread product that consists of underlying financial instruments; and
an match engine module that matches the order for the spread product with orders for the underlying financial instruments.

18. The trading system of claim 17, wherein the implied spread product module includes a processor programmed with computer-executable instructions to create a multiple financial instrument leg of the spread product having a nonstandard tick level with multiple financial instruments having prices that have standard tick levels and when combined result in the nonstandard tick level.

19. The trading system of claim 18, wherein the spread product comprises a butterfly spread product and the multiple financial instrument leg comprises a first financial instrument having a price at a standard tick level below the nonstandard tick level and a second financial instrument having a price at a standard tick level above the nonstandard ticket level.
